(19) United States
(12) Patent Application Publication
(10) Pub. No.: US 2009/0252851 A1
(43) Pub. Date: Oct. 8, 2009

(54) TEA BEVERAGES AND METHODS RELATED THERETO

(76) Inventors: Monjur Hossen, Battle Creek, MI (US); Richard Norris Flaget, Richland, MI (US); Alan Baublis, Kalamazoo, MI (US)

Correspondence Address: Randall L. Shoemaker;Dickinson Wright PLLC, 38525 Woodward Ave., Ste. 2000, Bloomfield Hills, MI, 48304-2970, US

(21) Appl. No.: 12/417,198

(22) Filed: Apr. 2, 2009

Related U.S. Application Data
(60) Provisional application No. 61/042,395, filed on Apr. 4, 2008.

(51) Int. Cl. A23F 3/00

(52) U.S. Cl. 426/597; 426/435

(57) ABSTRACT

The present invention is directed to protein-fortified tea beverages, having little or no sedimentation, and low carbohydrate load. Also provided are tea beverages having protein, fiber, low carbohydrate load, little to no sedimentation, and a variety of other optional, enhancing ingredients. Also provided are methods to make such tea beverages.

### RELATED APPLICATIONS

This application claims priority to U.S. Provisional Patent Application Ser. No. 61/042395, on Apr. 4, 2008.

### FEDERAL GOVERNMENT FUNDING

No federal government funding was used for the purpose of the present application.

### BACKGROUND OF THE INVENTION

1. Field of the Invention

The invention relates to superior tea beverages and methods related to preparing such tea beverages. In particular, the invention relates to solving the sedimentation problem in tea beverages fortified with other components, such as, for example, protein and fiber.

2. Background

Traditional tea is a hot water extraction of many components from tea leaves. Commercial production of tea is currently accomplished either by water-extraction or solvent-extraction. Such commercial tea extracts are sold as concentrates, and, as such, are considered by those in the art as an ingredient.

Consumers are increasingly interested in ready-to-drink tea that provides components that are not present in a simple extraction. For instance, flavorings, colorings, juices, sweeteners, etc. have been mixed with a tea leaf extraction, and marketed as an improvement over the extraction.

Such tea or tea-flavored drinks are part of a broader market of ready-to-drink beverages that offer functionality. For example, so-called “energy drinks” often contain high levels of caffeine and carbohydrate(s), in addition to tea and protein. At first glance, the carbohydrate(s) would seem to function as an energy source, but they also serve to increase viscosity and thereby suspend solids. Moreover, incorporating such solids often results in a cloudy appearance. Since cloudiness is unlike traditional tea, such drinks do not resemble traditional tea.

### SUMMARY OF THE INVENTION

The present invention provides tea beverages comprising water-extracted tea, protein, and optional other ingredients, such as fiber.

A preferred tea beverage is one which comprises less than 2% non-artificial sweetener.

A more preferred tea is sweetened with sucralose, most preferably, a combination of sucrose, sucralose and acesulfame-K.

A preferred tea beverage is one in which the tea extract is selected from the group consisting of: white tea; green tea; and black tea; most preferably, black tea.

Another preferred tea beverage is one in which the protein is whey protein; including whey protein isolates of all types.

Another preferred tea beverage is one in which fiber is added; preferably, the fiber selected from the group consisting of: polydextrose; plant fiber; and microground fiber.

Most preferred is a tea beverage in which the fiber is polydextrose, including Litesse brand from Danisco.

The most preferred embodiment of the present invention is a sedimentation-resistant tea beverage comprising water-extracted black tea, sucralose, whey protein and polydextrose.

A preferred tea beverage comprises 90 to 99% water, less than 2% sugar; 0.8 to 1.5% protein, and 0.05 to 1% water-extracted tea extract, wherein said tea beverage is sedimentation-resistant.

A more preferred tea beverage comprises 90 to 99% water, less than 1.5% sugar, 0.8 to 1.5% protein, 0.05 to 1% water-extracted tea extract, and 0.9 to 1.3% polydextrose, wherein said tea beverage is sedimentation-resistant.

Also provided are methods to make a sedimentation-resistant tea beverage, comprising: combining water-extract tea, whey protein and water so as to create a sedimentation-resistant tea.

Such methods preferably include those which further comprise combining less than 2% non-artificial sweetener, and optionally combining polydextrose into the mixture.

Other optional steps include combining water, antifoamer, whey protein, sucrose, acesulfame-K, sucralose, water-extracted tea extract, and polydextrose; and optionally holding the combination of ingredients from step a) so as to promote protein hydration.

Other optional steps comprise adjusting acidity, adding flavors, and adding vitamins.

Other optional steps comprise adjusting the BRIX.

Other optional steps comprise dispensing the beverage into containers using a hot fill process, more preferably at these conditions: at 189 to 195° F., a flow rate 42 to 52 gallons per minute, a holding time of sixty seconds, and a tube outlet temperature of 185° F., a bottle fill temperature of 178 to 183° F., and a cool down temperature of 100° F.

### BRIEF DESCRIPTION OF THE DRAWING

FIG. 1. FIG. 1 is a simplified flow diagram of a process according to an exemplary embodiment of the invention.

### DETAILED DESCRIPTION

The present invention provides low-carbohydrate, sedimentation-resistant tea beverages comprising ordinarily-sedimenting components: protein, and optionally, fiber. Prior to the present invention, such a formulation relied on a high BRIX to suspend the sedimenting components. As a result, these beverages were high in calories, cloudy, and undesirable to some consumers.

The present tea beverages provide satiety-providing ingredients without a concurrent carbohydrate load. Another beneficial attribute is that the tea beverages have a long shelf life and sediment will not form over a reasonable life of the product. Moreover, the beverages were not cloudy, despite the solids content. Such tea beverages and the methods to make them are described herein in detail.

As used herein the term “tea extract” means a tea-containing composition in which the amount of tea solids present is greater than would be present in a tea beverage intended to be consumed by a consumer. Tea extracts may be powders or liquids. The amount of tea solids in a liquid concentrated tea extract may be greater than 3%, preferably greater than 8%, more preferably greater than 12% by weight of the tea concentrate. Concentrated tea extracts may be produced by direct extraction into water or by partially or completely removing the water from an infusion of tea leaves in water to give liquid and powder concentrated tea extracts respectively.

Tea extracts having an amount of tea solids usually associated with tea beverages suitable for consumption by a consumer are hereinafter referred to as “tea beverage”. Consumable tea beverages may comprise an amount of tea solids which may be less than 1%, preferably less than 0.8%, more preferably less than 0.5% by weight of the tea extract. In particularly preferred consumable tea beverages, the amount of tea solids in the tea beverage may be in the range 0.04 to 0.35% by weight of the tea extract

A tea beverage may be a consumable tea extract or it may be made by adding water (hot or cold) to concentrated tea extracts. Tea beverages may be made by adding the water to the concentrated tea extracts immediately prior to consumption or they may be prepared and placed in a container (for example a bottle or can) for supply to the consumer as a ready-to-drink tea beverage.

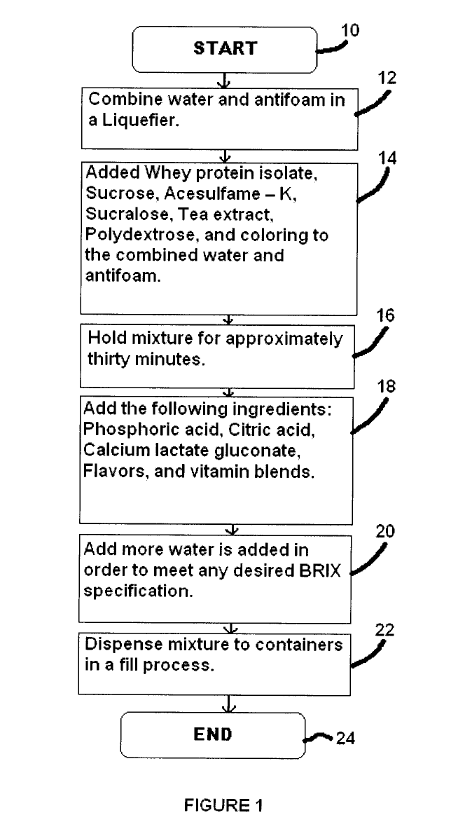

As set forth above, FIG. 1 is a simplified flow diagram of a preferred process of the invention. At step 12, water and antifoam are combined in a mixer, such as, for example, what is known in the art as a “liquefier.” Next, at step 14, the following ingredients are added, ideally, but not necessarily, in the following order: whey protein isolate, sucrose, acesulfame-K, sucralose, water-extracted tea extract, polydextrose, and coloring.

At step 16, the mixture is held for, ideally, approximately thirty minutes, to promote and/or ensure protein hydration. At step 18, the following optional ingredients are added, ideally, but not necessarily, in the following order: phosphoric acid, citric acid, calcium lactate gluconate, flavors, and vitamin blends.

At step 20, more water is optionally added to adjust the BRIX specification, if desired. At step 22, the mixture is ideally dispensed to containers in a hot fill process. In this example, the temperature of the mixture can be set at 189 to 195° F. and at a flow rate 42 to 52 gallons per minute. The holding time can be sixty seconds. The holding time can be sixty seconds and the holding tube outlet temp can be set at 185° F. The bottle fill temperature can be set at 178 to 183° F. The cool down time to less than 100° F. can be two and one-half minutes. The exemplary process ends at step 24. All of times, measurements, and settings are approximate.

It is noted that other methods for eliminating organisms from the beverage can be applied in alternative embodiments of the invention. The mixture may be dispensed in a cold fill operation. Aseptic high acid processing can be applied. Also, extended shelf life (“ESL”) can be practiced in an alternative embodiment of the invention.

In its broadest sense, our invention that is described in an exemplary manner herein, may be applicable to many other potable liquids, including coffee. It also noted that the invention may be applicable to solvent extracted tea if process changes were applied.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A sedimentation-resistant tea beverage, comprising: water-extracted tea extract and protein.

2. A tea beverage of claim 1, wherein the tea extract is selected from a group consisting of: white tea extract, green tea extract, and black tea extract.

3. A tea beverage of claim 1, which further comprises less than 2% non-artificial sweetener.

4. A tea beverage of claim 1, which further comprises fiber.

5. A tea beverage of claim 1, which further comprises polydextrose.

6. A tea beverage of claim 3, wherein the protein is whey protein.

7. A tea beverage of claim 6, wherein the fiber is polydextrose.

8. A tea beverage of claim 7, which comprises an artificial sweetener.

9. A tea beverage of claim 8, comprising: 90 to 99% water; less than 2% non-artificial sweetener; 0.8 to 1.5% protein; and 0.05 to 1% water-extracted tea extract, wherein said tea beverage is sedimentation-resistant.

10. A method to make a sedimentation-resistant tea beverage, comprising: combining water-extract tea, whey protein and water so as to create a sedimentation-resistant tea.

11. A method of claim 10, which further comprises combining less than 2% non-artificial sweetener.

12. A method of claim 11, which further comprises combining polydextrose.

13. A method to make a sedimentation-resistant tea beverage, comprising the steps of:
a) combining water, antifoamer, whey protein, sucrose, acesulfame-K, sucralose, water-extracted tea extract, and polydextrose; and
b) holding the combination of ingredients from step a) so as to promote protein hydration.

14. A method of claim 13, which further comprises adding adjusting acidity, adding flavors, and adding vitamins.

15. A method of claim 14, which further comprises adjusting the BRIX.

16. A method of claim 15, which further comprises dispensing the beverage into containers using a hot fill process, at 189 to 195° F., a flow rate 42 to 52 gallons per minute, a holding time of sixty seconds, and a tube outlet temperature of 185° F., a bottle fill temperature of 178 to 183° F., and a cool down temperature of 100° F.
